(19) United States
(12) Patent Application Publication
(10) Pub. No.: US 2004/0054587 A1
(43) Pub. Date: Mar. 18, 2004

(54) System and method for managing private consumer accounts using branded loyalty cards and self-service terminals

(76) Inventors: Roger A. Dev, Durham, NH (US); Mark Samber, Portsmouth, NH (US)

Correspondence Address: HAYES SOLOWAY P.C., 175 Canal Street, Manchester, NH, 03101, US

(21) Appl. No.: 10/620,719

(22) Filed: Jul. 16, 2003

Related U.S. Application Data
(60) Provisional application No. 60/396,188, filed on Jul. 16, 2002.

(51) Int. Cl. G06F 17/60

(52) U.S. Cl. 705/14; 238/380

(57) ABSTRACT

An identification medium system contains a computer-readable medium having a plurality of consumer profiles stored thereon, each consumer profile containing private account data relating to a consumer; and a terminal in communication with the computer-readable medium. The terminal containing a processor, a memory, and at least one media reader adapted to read (1) a first account tag stored on a first identification medium, wherein the first account tag corresponds to at least one consumer profile, and (2) a second account tag stored on a second identification medium (e.g., a credit or debit card issued by a financial institution). The processor is configured by the memory (1) to store on the computer-readable medium an association between the second account tag and the consumer profile corresponding to the first account tag, and (2) to permit retrieval or modification of at least a portion of the private account data of the consumer profile corresponding to the first account tag upon subsequent reading by the media reader of the second account tag stored on the second identification medium.

### CROSS-REFERENCE TO RELATED APPLICATION

This application claims priority to co-pending U.S. Provisional Application serial No. 60/396,188 entitled “Method and Apparatus for the Management of Private Consumer Accounts using Branded Loyalty Cards and Self-Service Terminals,” filed Jul. 16, 2002, which is incorporated herein by reference in its entirety.

### FIELD OF THE INVENTION

The present invention relates, generally, to branded customer loyalty media, and more particularly, to a system and method for the use of such media in a self-service terminal environment.

### BACKGROUND OF THE INVENTION

Branded loyalty and affinity cards (hereinafter, “loyalty/affinity cards”) are devices, typically plastic cards, given by a retailer to its customers, who present the card to the retailer whenever they make a purchase. These cards utilize a variety of encoding mechanisms such as magnetic stripes, bar codes or radio frequency identification (RFID), and can take various forms, including credit-card type cards, flat key fob cards, wands, and even vehicle-mounted transponders.

The process flow of an exemplary loyalty/affinity card system 100 is illustrated in FIG. 1. At a cashier station, a customer enrolls for a loyalty card by filling out a paper-based enrollment form and handing the form to a cashier (block 101). The cashier then presents the customer with a loyalty/affinity card (block 102). The customer can then present the card at a cashier station upon checkout (block 103). The cashier scans the loyalty/affinity card (block 104), after which a point-of-sale (POS) terminal communicates with a database 110, which stores customer generated data therein, via a public or private network 111, e.g., to determine the award status of the customer, update the point balance of the customer, or generate instant award certificates for the customer (block 105). Meanwhile, the database 110 can be accessed in a number of ways by the merchant and third parties to perform a variety of functions using the customer-generated data in the database 110. For example, demographic mapping 112, direct marketing 113, third-party co-marketing 115, or customer service or help desk functions 116, may be performed using the data stored in the database 110 as input. Further, reports 114 may be generated from the data in the database 110, including, e.g., management reports 117, marketing reports 118, and security reports 119.

Customers benefit from the use of loyalty/affinity cards in several ways. A typical card user may receive discounted or free merchandise at the point of purchase through advertised or unadvertised specials only for cardholders. A customer using such a card may also accumulate credits in the form of “points” or “miles” based on the value of their purchases, such that the customer receives an award for accumulating a certain number of “points,” e.g., a discount or credit on a future purchase, or a shopping or travel voucher. Moreover, these cards are often tied to private credit or debit accounts at financial institutions, thereby permitting a card user to accumulate credits with a given merchant or group of merchants even while using the card to spend money elsewhere. An example of the above-described cards is a “frequent-flyer” bank credit card that awards “miles” for money spent anywhere, e.g., at grocery, drug or hardware stores.

Merchants also benefit enormously from the use of loyalty/affinity cards in a number of ways. By being able to identify a customer at the point of sale, merchants can track or profile individual or collective customer purchasing patterns, e.g., to drive targeted promotions or advertising. Moreover, merchants can thereby differentiate their retail establishment in the minds of customers, thereby encouraging customers to return to their stores, rather than shopping elsewhere. In fact, for years, affinity marketing has been used successfully to build relationships between companies and their customers. Major airlines, hotels and restaurants have made regular use of affinity cards to promote, facilitate, and reward frequent purchasing. While companies in such travel-related industries have refined the art of affinity marketing throughout the years, many other industries have yet to realize the potential that affinity marketing holds for them, and it is believed that the use of loyalty/affinity cards will continue its rapidly expanding trend, which now encompasses, for example, pet supply, hardware and clothing stores, casinos, restaurants, museums, golf courses, flower shops, and even non-profit organizations and charities.

Unfortunately, a major problem with the current trend is that consumers are being forced to bear the burden of carrying an ever-increasing number of loyalty/affinity cards in their wallets or on their key chains, as more and more merchants adopt these cards and require the customer to present the card on a regular basis. Therefore, a need exists in the industry to address the issue of reducing the number of cards a consumer must carry, without limiting the number of loyalty/affinity programs in which the consumer can participate.

Thus, a heretofore unaddressed need exists in the industry to address the aforementioned deficiencies and inadequacies.

### SUMMARY OF THE INVENTION

The present invention provides a system and method for use of branded customer loyalty/affinity cards or other media in a self-service terminal environment, which solves the customer problem of having to carry a large number of loyalty/affinity media and provides a number of other customer and merchant benefits.

Briefly described, in architecture, one embodiment of the system, among others, can be implemented as follows. The system contains storage for (1) a plurality of consumer profiles, each consumer profile containing private account data relating to a consumer, (2) an association between a first account tag stored on a first identification medium and at least one consumer profile, and (3) an association between a second account tag stored on a second identification medium and the consumer profile associated with the first account tag. The system also contains a terminal in communication with the storage, the terminal containing a memory, a processor, and at least one media reader adapted to read at least one of the first and second account tags, wherein the processor is configured by the memory to permit retrieval or modification of at least a portion of the private account data of the consumer profile associated with the first account tag upon the media reader reading the at least one of the first or second account tags.

The present invention can also be viewed as providing methods for performing a transaction in an identification medium system. In this regard, one embodiment of such a method, among others, can be broadly summarized by the following steps: storing a plurality of consumer profiles, each consumer profile comprising private account data relating to a consumer; reading a first account tag stored on a first identification medium, wherein the first account tag corresponds to at least one consumer profile; reading a second account tag stored on a second identification medium; storing an association between the second account tag and the consumer profile corresponding to the first account tag; and permitting retrieval or modification of at least a portion of the private account data of the consumer profile corresponding to the first account tag upon subsequent reading of the second account tag stored on the second identification medium.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a process flow diagram of an exemplary loyalty/affinity card system.

FIG. 2 is a system diagram of an exemplary Identification Medium system consistent with one embodiment of the present invention.

FIG. 3 is a relationship diagram illustrating an exemplary association between Public and Private Consumer Profiles within an account record in the exemplary Identification Medium system of FIG. 2.

FIG. 4 is a flowchart of an exemplary “Read Profile” access method in the exemplary Identification Medium system of FIG. 2.

FIG. 5 is a flowchart of an exemplary “Write Profile” access method in the exemplary Identification Medium system of FIG. 2.

FIG. 6 is a flowchart of an exemplary method for associating an alias Identification Medium with a primary Consumer Profile and subsequently using the alias Identification Medium in the exemplary Identification Medium system of FIG. 2.

FIG. 7 is a block diagram of an exemplary Self-Service Terminal in the exemplary Identification Medium system of FIG. 2.

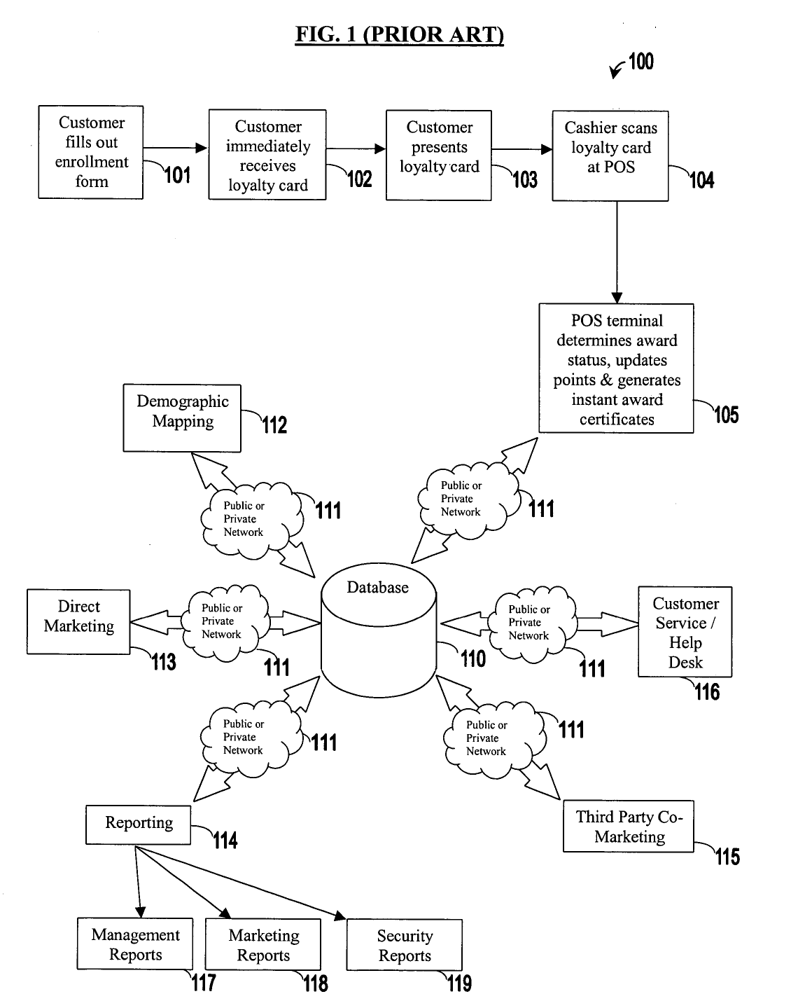

### DETAILED DESCRIPTION

### Definitions

It should be noted that the following definitions are used herein, throughout the specification and claims.

Identification Medium—Any machine-readable medium that encodes an identification “tag” such as an account number or identification number, e.g., a charge/credit card, a debit card, a loyalty/affinity card, a customer identification card, a radio-frequency identification (RFID) wand or tag, or a driver's license.

Private Identification Medium—Any Identification Medium that uniquely identifies an individual customer or account within the scope of a supplier of merchandise or services (such as a merchant establishment or chain), e.g., a private charge card, a private debit card, a branded loyalty card, a preferred customer card, or an RFID wand or tag. These media encode at least an Account Tag (e.g., account number), which is used to uniquely identify a Private Account.

Public Identification Medium—Any Identification Medium that uniquely identifies a customer or account globally, or within the scope of a public identification authority recognized by a plurality of merchants, e.g., well-known credit cards or bank debit cards. These media encode at least an Account Tag (e.g., account number) that is used to uniquely identify a Public Account. These media frequently encode additional information that is useful in a transaction, e.g., customer name and expiration date.

Private Account—A repository of information regarding a consumer or consumer group that is maintained by a merchant establishment or limited group of merchant establishments. This account may offer any number of features to the consumer including, e.g., the ability to buy on credit, the ability to populate with value and use as a debit card, and the ability to track a the buying history and patterns of a consumer.

Public Account—An account similar to a Private Account, except that it is designed to provide services spanning many merchant establishments. The account information (e.g., Consumer Profile) associated with these accounts is usually unavailable to the merchant, except in severely limited form, e.g., the ability to determine whether sufficient balance exists to make a given purchase.

Account Tag—A string of information that uniquely identifies a Public or Private Account. Examples of such information include, but are not limited to, account numbers, telephone numbers, and driver's license or identification card numbers.

Consumer Profile—A database containing information about a consumer or consumer group, possibly including transaction histories. There is typically a Consumer Profile associated with any Private or Public Account. Since this specification primarily relates to the management of Private Accounts, references to Consumer Profiles herein will generally be directed to those associated with Private Accounts.

Self-Service Terminal—An automated station that allows a consumer to order or purchase items from a merchant and can read (i.e., decode) stored information located on at least one form of Private Identification Medium and, usually, at least one form of Public Identification Medium. These terminals may be on the merchant premises or remote from those premises. Consumers may interact with the Self-Service Terminal by various means including touch-screen, voice, keyboard, mouse, or trackball.

### System Overview

With reference now to FIG. 2, one embodiment of an exemplary Identification Medium system 200 consistent with the present invention will now be described. As shown, the system comprises a plurality of Private Identification Media 205, a plurality of Public Identification Media 206, one or more Self-Service Terminals 201, a Consumer Profile database 210, and various hardware/software systems for interfacing with the Consumer Profile database 210, e.g., a module 207 (e.g., a marketing or customer service module) adapted to use information from the Consumer Profile database 210 and a module 204 for editing the data in the Consumer Profile database 210.

Each of the Private Identification Media 205 has at least an Account Tag encoded thereon, used to identify uniquely a particular Private Account. Each of the Public Identification Media 206 has at least an Account Tag encoded thereon, used to uniquely identify a particular Public Account. The Public Identification Medium 206 may also have encoded thereon a limited set of information about the holder (e.g., name and age) of the Identification Medium 206.

The Self-Service Terminal 201 is a terminal adapted for in-person use by a customer, e.g., for ordering and/or paying for items ordered. The Self-Service Terminal 201 is in communication with the Consumer Profile database 210 via a network and comprises at least one media reader 202 adapted to read Account Tags stored on Private 205 and Public Identification Media 206 and to decode encoded information located on a Public Identification Medium 206. The Self-Service Terminal 201 may also contain one or more cash acceptors and/or dispensers 203 for receiving and/or dispensing cash (e.g., in the form of bills and/or coins). The Self-Service Terminal 201 may be embodied in a number of combinations of hardware and software, which will be discussed in further detail hereinbelow under the section heading “Hardware and Software Configuration.”

The Consumer Profile database 210 is capable of storing consumer information, e.g., name, age, sex, and purchasing history, and such information is indexed by Account Tag so that it can be located for reading or modification, e.g., upon customer presentation of a Private 205 or Public Identification Medium 206.

Various external systems or modules may be in communication with the Consumer Profile database 210 via a network and may be adapted to utilize or modify information in the Consumer Profile database 210, including, e.g., marketing or customer service modules 207 adapted to use information from the Consumer Profile database 210, or modules 204 for editing data in the Consumer Profile database 210.

A system consistent with the present invention may be utilized by a single merchant or a group of merchants, and one or more Self-Service Terminals 201 or other devices for accessing and interacting with the data in the Consumer Profile database 210, and may be located on the premises of one or more merchants or remote therefrom.

In various embodiments, the Identification Medium system 200 permits one or more of the following potential associations to be made, which associations may be stored in the Consumer Profile database 210: (1) association of Private Identification Medium and Public Identification Medium; (2) association of multiple Public Identification Media to a single Private Identification Medium; (3) automatic population of a Private Consumer Profile with information encoded on one or more Public Identification Media; (4) association of multiple Private Sub-Accounts to a primary Private Account; and (5) association of inputted cash (credits) or outputted cash (debits) to a Consumer Profile. These associations will be discussed in further detail hereinbelow under the section heading “Self-Service Terminal.”

### Consumer Profile Database

For each consumer account, the Consumer Profile database 210 may include a plurality of account records comprising one or more of the following types of fields or attributes: (1) Account Tag (e.g., a Private Identification Medium Account Tag); (2) name; (3) age; (4) address; (5) contact information (e.g., telephone numbers); (6) preferences; (7) selected account options; (8) list of associated Public Identification Medium Account Tags; (9) list of purchases; (10) statistics compiled based on purchase history; (11) credit or debit balance; (12) account limitations; and (13) other application-specific attributes related to the consumer. Each account record may be accessible using the Account Tag as a key.

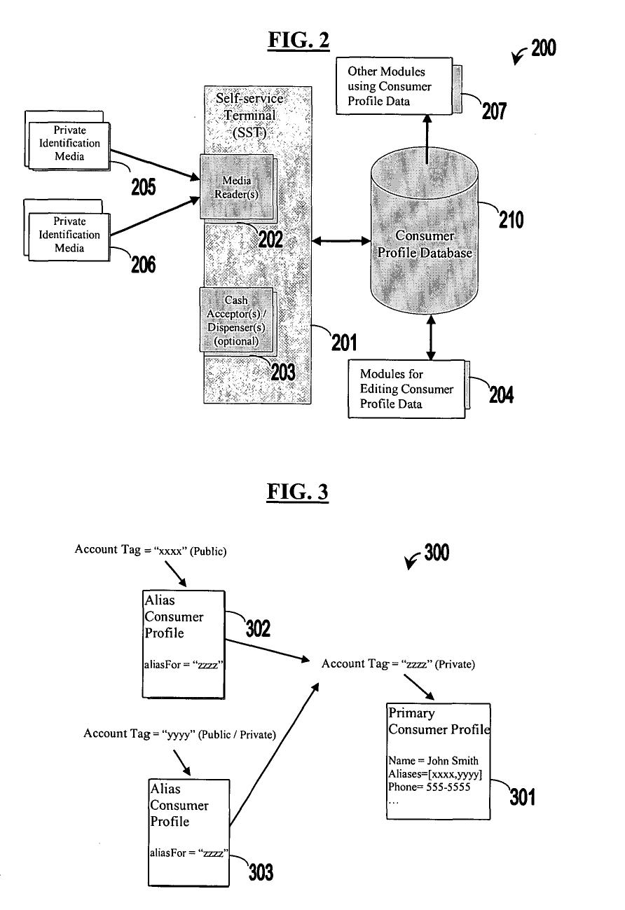

FIG. 3 is a relationship diagram illustrating an exemplary association between Public and Private Consumer Profiles within an account record in the exemplary Identification Medium system of FIG. 2. As illustrated in FIG. 3, an account record 300 may also include an “aliasFor” field, which is used to relate alternate or “alias” Account Tags, e.g., Public Identification Medium Account Tags (corresponding to alias Identification Media 302, 303), to a primary Consumer Profile 301. This relation allows multiple Identification Media 205, 206 (FIG. 2) to refer to a single account. As shown, a primary Consumer Profile 301 for a private Identification Medium 205 (FIG. 2) having an Account Tag of “zzzz” is associated with an alias Consumer Profile 302 for a Public Identification Medium 206 (FIG. 2) having an Account Tag of “xxxx” and an alias Consumer Profile 302 for a Public or Private Identification Medium 205, 206 (FIG. 2) having an Account Tag of “yyyy”. Each of the alias Consumer Profiles 302, 303 contain an “aliasFor” field of “zzzz” to relate the alias Consumer Profiles 302, 303 to the primary Consumer Profile 301. It should be recognized that the account record that holds the primary Consumer Profile 301 itself does not need to contain any “aliasFor” field, since the alias information is already stored in the alias Consumer Profiles 302, 303 for the corresponding alias Account Tags. In this scenario, the operative Consumer Profile used for a transaction is the overlay of the alias Consumer Profile 302, 303 contents (excepting the “aliasFor” attribute) on top of the contents of the target primary Consumer Profile 301. This allows attributes associated with the alias (such as restrictions) to be in effect whenever an Identification Medium having an alias Account Tag is used.

It should be recognized that, while FIG. 3 and the corresponding foregoing description illustrate only a single level of aliasing, it is contemplated that in appropriate situations, multiple levels of aliasing and associated Consumer Profile overlays may be employed. It should further be recognized that a Consumer Profile may be encrypted to protect its privacy using any of the widely available symmetric or asymmetric encryption techniques, e.g., DES (Data Encryption Standard), Triple-DES, or Blowfish. The keys (i.e., Account Tags) may also be stored in an encrypted form.

### Database Access Routines

In the exemplary Identification Medium system of FIG. 2, a pair of routines, ReadProfile and WriteProfile, may be used to access a Consumer Profile in the Consumer Profile database 210.

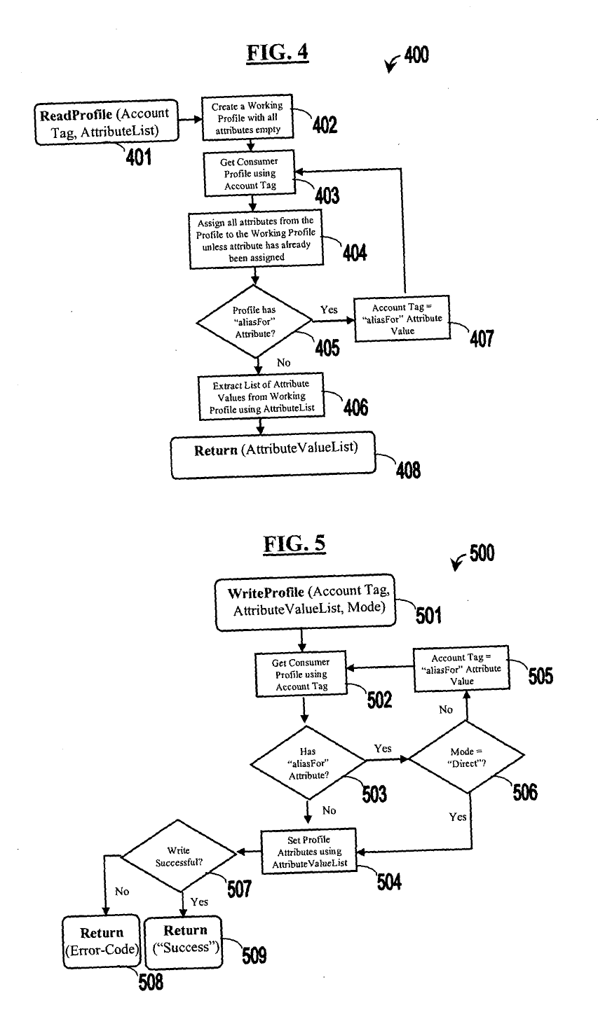

FIG. 4 is a flowchart of an exemplary “Read Profile” access method in the exemplary Identification Medium system of FIG. 2. As illustrated in the flowchart of FIG. 4, a call to the ReadProfile routine 400 specifies parameters AccountTag and AttributeList, and the set AttributeValueList is returned. For this routine, AttributeList is a list comprising AttributeName, and AttributeValueList is a list comprising one or more sets of (AttributeName, AttributeValue). As shown in FIG. 4, the routine 400 is first called using the AccountTag and AttributeList parameters (block 401). Next, a working Consumer Profile is created with the attributes empty (block 402). As is shown by block 403, the Consumer Profile is retrieved using the Account Tag. Attributes are then assigned from the Consumer Profile to the working Consumer Profile, unless a particular attribute has already been assigned, in which case the attribute remains unchanged (block 404). A determination is then made as to whether the Consumer Profile has the “aliasFor” attribute (block 405). If not, a list of attribute values is extracted from the Working Profile using the AttributeList (block 406). If it is determined that the Consumer Profile has the “aliasFor” attribute, the “aliasFor” AttributeValue is assigned as the AccountTag (block 407). The routine 400 then returns the corresponding AttributeValueList (block 408).

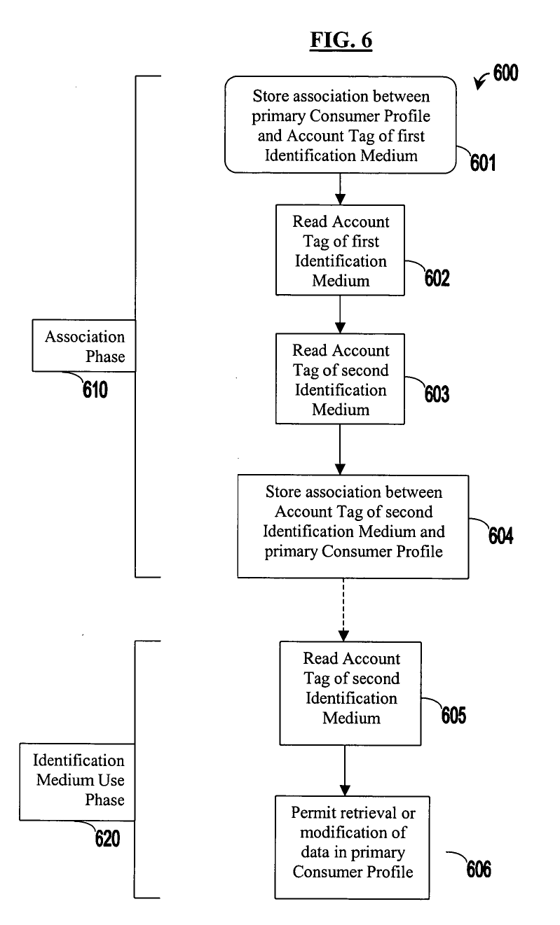

FIG. 5 is a flowchart of an exemplary “Write Profile” access method in the exemplary Identification Medium system of FIG. 2. As illustrated in the flowchart of FIG. 5, a call to the WriteProfile routine 500 specifies parameters AccountTag, AttributeValueList, and Mode, and a Status flag is returned. For this routine, Mode can be either Direct, which is used to write “aliasFor” records, or Normal, which follows the chain of aliases and writes to the primary Consumer Profile. The Status flag is either a Success or an Error Code. As shown in FIG. 5, the routine 500 is called using the AccountTag, AttributeValueList, and Mode parameters (block 501). Next, the corresponding Consumer Profile is retrieved using the AccountTag (block 502). As is shown by block 503, a determination is made whether the Consumer Profile has the “aliasFor” attribute. If not, the Consumer Profile attributes are set using AttributeValueList (block 504). If it is determined that the Consumer Profile has the “aliasFor” attribute, then a further determination is made whether Mode is Direct (block 506). If so, the Consumer Profile attributes are set using AttributeValueList. If Mode is determined not to be Direct (i.e., Mode is Normal), the “aliasFor” AttributeValue is assigned as the AccountTag (block 505), and the corresponding Consumer Profile is retrieved using the AccountTag (block 502). After the Consumer Profile attributes are set using AttributeValueList (block 504), a determination is made as to whether the write was successful (block 507). If not, an Error Code is returned (block 508). If it is determined that the write was successful, a Success code is returned (block 509).

It should be noted that any process descriptions or blocks in flowcharts described or illustrated herein should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

### Self-Service Terminal

The exemplary Self-Service Terminal 201 illustrated in FIG. 2 is adapted to read stored data on both Public and Private Identification Media by means of the media reader 202 and to access Private Consumer Profiles in support of a number of scenarios, which are described hereinbelow. It should be recognized that, although the Self-Service Terminal 201 is described herein as being a terminal for personal self-service use by a customer, the functionality of the Self-Service Terminal 201 in certain embodiments may alternatively be provided by a terminal or other device adapted for use by a person other than the customer, e.g., a cashier or customer service representative.

Use of Private Identification Medium—Private Identification Medium-based accounts may be supported using the following exemplary steps: First, a consumer presents a Private Identification Medium to be read by the Self-Service Terminal (e.g., by insertion of a card having a magnetic strip). The Self-Service Terminal 201 then uses the encoded Account Tag on the Private Identification Medium 205 to look up and retrieve the corresponding Consumer Profile. The Self-Service Terminal 201 can then perform an appropriate function using the Consumer Profile information, e.g., to service the cardholder, or to update the information in the Consumer Profile.

Association of Public Identification Medium with Private Account—Public Identification Medium-based accounts may be associated with a corresponding Private Account using the following exemplary steps: First, a consumer presents a Private Identification Medium 205 to be read by the Self-Service Terminal 201 (e.g., by insertion of a card having a magnetic strip). The Self-Service Terminal 201 then uses the encoded Account Tag on the Private Identification Medium 205 to look up and retrieve the corresponding Consumer Profile. At some point in the transaction (e.g., at checkout), the consumer presents a Public Identification Medium 206 to be read by the Self-Service Terminal 201 (e.g., by insertion of a card having a magnetic strip). The Self-Service Terminal 201 then uses the encoded Account Tag on the Public Identification Medium 206 to look up and retrieve the corresponding Public Consumer Profile. The Self-Service Terminal 201 presents the consumer with the option of associating the Public Identification Medium 206 with the Private Account, e.g., by asking “Shall I save your charge card information in a secure server so that you can use it as your Loyalty Card in the Future?” If the consumer answers affirmatively, the Self-Service Terminal 201 writes a new Consumer Profile using the WriteProfile (using Mode=“Direct”) containing an alias for the Private Account Tag (i.e., by means of the “aliasFor” attribute). For each Consumer Profile item encoded within the Public Identification Medium 206, if the value is blank in the Consumer Profile, the Self-Service Terminal 201 writes the value from the Public Identification Medium 206 into the Consumer Profile (e.g., Name) using Mode=“Normal”. The Self-Service Terminal 201 then adds the Public Identification Medium Account Tag into the list of aliases for the Consumer Profile (using Mode=“Normal”), along with any needed auxiliary payment information (e.g., expiration date). The Public Identification Medium 206 is now associated with the Private Account.

Use of Public Identification Medium to access a Private Account—Once a Public Identification Medium 206 has been associated with a Private Account (as described hereinabove), the consumer can use the Public Identification Medium 206 as an alias for the Private Identification Medium 205 through the following exemplary steps: First, the consumer presents a Public Identification Medium 206 to be read by the Self-Service Terminal 201 (e.g., by insertion of a card having a magnetic strip). The Self-Service Terminal 201 then uses the encoded Account Tag on the Public Identification Medium 206 to look up and retrieve the corresponding Consumer Profile. This can be effected via the ReadProfile routine, which finds the alias Consumer Profile and uses the “aliasFor” value to find and retrieve the primary Consumer Profile. The Self-Service Terminal 201 can then perform an appropriate function using the Consumer Profile information, e.g., to service the cardholder, or to update the information in the Consumer Profile.

Use of Private Identification Medium to access a Public Account—Once a Public Identification Medium 206 has been associated with a Private Account (as described hereinabove), the consumer can access the Public Account features using the Private Identification Medium 205 through the following exemplary steps: First, a consumer presents a Private Identification Medium 205 to be read by the Self-Service Terminal 201 (e.g., by insertion of a card having a magnetic strip). The Self-Service Terminal 201 then uses the encoded Account Tag on the Private Identification Medium 205 to look up and retrieve the corresponding Consumer Profile. At some point in the transaction (e.g., at checkout), the consumer wishes to access a feature of the Public Account, e.g., to pay using a Public charge or debit card. The Self-Service Terminal 201 then presents the consumer with a choice of which (of any associated Public Accounts) to use (e.g., by presenting a list), and the consumer selects a Public Account. The Self-Service Terminal 201 submits a credit or debit transaction to the service center corresponding to the Public Account (e.g., via phone line) using the Public Account Tag and any associated payment information. The service center either accepts or rejects the transaction, and the Self-Service Terminal 201 notifies the consumer of the result.

Association of Multiple Private Identification Media with a Private Account—For various reasons, it may be desirable for multiple Private Identification Media 205 to be associated with a single Private Account. This could be used, e.g., to create Sub-Accounts for each child in a family, all linked to a primary Private Account for the head-of-household. This would allow, e.g., a card lost by a child to be de-activated without disabling the entire Private Account. It could also be used to apply other attributes to the Sub-Accounts such as per-order size limitations (e.g., orders<=$5.00) providing additional protection. This may be done using a similar mechanism to that used for associating a Public Identification Medium 206 with a Private Account, using the following exemplary steps: First, a consumer presents a Private Identification Medium 205 that corresponds to the primary Private Account, to be read by the Self-Service Terminal 201 (e.g., by insertion of a card having a magnetic strip). The Self-Service Terminal 201 then uses the encoded Account Tag on the Private Identification Medium 205 to look up and retrieve the corresponding Consumer Profile. At some point in the transaction (e.g., at checkout), the consumer presents a second Private Identification Medium 205 to be read by the Self-Service Terminal 201 (e.g., by insertion of a card having a magnetic strip). The Self-Service Terminal 201 then uses the encoded Account Tag on the second Private Identification Medium 205 to look up and retrieve the corresponding Private Consumer Profile. The Self-Service Terminal 201 presents the consumer with the option of associating the second Private Identification Medium 205 with the primary Private Account, e.g., by asking “Shall I join this card to your account named ‘Smith Family’?” If the consumer answers affirmatively, the Self-Service Terminal 201 writes a new Consumer Profile using the WriteProfile (using Mode=“Direct”) containing an alias for the primary Private Account Tag (i.e., by means of the “aliasFor” attribute). The user may then be asked whether the user wishes to tie any features or restrictions to the Sub-Account that are not on the primary Private Account (e.g., per-transaction price limits). Any such restrictions are written to the Consumer Profile (using Mode=“Direct”) for the Sub-Account. The Sub-Account Tag is added into the list of aliases for the Consumer Profile (using Mode=“Normal”). The second Public Identification Medium 206 is now associated with the primary Private Account.

Use of Private Identification Medium to access Another Private Account—Once a Private Identification Medium has been associated with a primary Private Account (as described hereinabove), the consumer can present the Sub-Account Private Identification Medium, e.g., at checkout. The transaction will, thereafter, be governed by the Consumer Profile for the primary Account, overlaid with any exceptions from the Sub-Account profile (e.g., transaction size restrictions).

Association of Inputted Cash (Credits) or Outputted Cash (Debits) to a Private Account—A user at a Self-Service Terminal 201 may wish to populate a Private Account with cash to use, e.g., as a gift card, or as a disposable or rechargeable Private Identification Medium. This may be achieved using the following exemplary steps: First, a consumer presents a Private Identification Medium 205 that corresponds to the Private Account, to be read by the Self-Service Terminal 201 (e.g., by insertion of a card having a magnetic strip). The Self-Service Terminal 201 then uses the encoded Account Tag on the Private Identification Medium 205 to look up and retrieve the corresponding Consumer Profile. The Self-Service Terminal 201 presents the user with a list of various functions from among which the user can select an “Add Cash” function. The Self-Service Terminal 201 directs the user to input cash to the terminal, and the user inputs cash to the terminal (i.e., in the form of coins or bills) through one or more cash acceptor components 203. The Self-Service Terminal 201 adds the corresponding cash amount to the account balance attribute of the Private Account. During future purchases using that Private Identification Medium 205, the Self-Service Terminal 201 presents the user with the option “Pay with Cash Balance.” Upon selecting this option, the price of that transaction will then be deducted from the account balance attribute of the Private Account. Alternatively, a consumer may wish to use a Public charge account to populate the Private Account. Exemplary steps for this scenario are similar to the foregoing described steps, except that instead of presenting cash, the consumer presents a Public Identification Medium 206 and chooses an amount to withdraw from the Public Account. This amount is then added to the balance in the Private Account and can be used as described hereinabove. A similar approach can also be used to manage private credit accounts, in which consumers may have a credit limit, up to which they are permitted to receive goods or services before needing to pay. Exemplary steps for this scenario are similar to the foregoing described steps, except that the balance is allowed to go negative (to within the credit limit). Consumers may then later select the “Add Cash” function or a “Credit Card” function to pay down their balance. It should be noted that the cash dispenser can also be used to provide cash needs for the consumer, similar to the “cash back” service allowed at many grocery stores. Here, consumers may receive cash from the Self-Service Terminal 201, which adds to the Private Account debit (or is paid as a Public Account debit) in any of the scenarios above.

### Alternative Methods of Consumer Profile Access

It is anticipated that several alternative mechanisms may exist for editing of Consumer Profile information, in addition to those provided at the Self-Service Terminal 201. These may include public network sites (e.g., Internet web sites) allowing consumers to edit their own Consumer Profiles, merchant-accessible application systems that allow additional information to be stored or edited, and telephone accessible systems allowing consumers or merchants to modify or access Consumer Profiles. It is also anticipated that there may be other applications that may utilize the Consumer Profile information. For example, a module 207 may be adapted to use information from the Consumer Profile database 210 for direct marketing purposes, e.g., generating customer mailing lists. As another example, a module 210 may be adapted for editing the data in the Consumer Profile database 210, e.g., a Web interface for customers to update their personal contact information. Any available information access techniques may be employed for this purpose.

### Exemplary Method for Association and Use of Alias Identification Medium

FIG. 6 is a flowchart of an exemplary method for associating an alias Identification Medium with a primary Consumer Profile and subsequently using the alias Identification Medium in the exemplary Identification Medium system of FIG. 2.

The flowchart 600 of FIG. 6 illustrates generally the process of associating an alias Identification Medium (either Public or Private) with a primary Private Account (“Association Phase” 610) and the subsequent use of the alias Identification Medium (“Identification Medium Use Phase” 620). As shown, in the Association Phase 610, the primary Private Account is initialized, i.e., by associating a primary Consumer Profile with the Account Tag of a primary Identification Medium (block 601). The foregoing initialization may be effected using the Self-Service Terminal 201 or another interface with the Consumer Profile database 210, and may be performed by someone other than the user of the primary Identification Medium (e.g., a cashier or customer service representative). At the Self-Service Terminal 201, a user presents the primary (first) Identification Medium to be read by the media reader 202 (block 602). The user then presents the alias (second) Identification Medium to be read by the media reader 202 (block 603). The Self-Service Terminal 201 then stores the association between the alias Account Tag and the primary Consumer Profile (block 604), which completes the Association Phase 610. Subsequently, to use the alias Identification Medium (i.e., Identification Medium Use Phase 620), the user presents the alias Identification Medium to be read by the media reader 202 (block 605). The Self-Service Terminal 201 then permits retrieval or modification of data in the primary Consumer Profile (block 606), so that the user may access various functions, e.g., via execution of the ReadProfile and WriteProfile routines, as described hereinabove.

### Benefits to Consumers and Merchants

In a system consistent with the present invention, a number of benefits inure to both the consumer and the merchant(s):

On the consumer side, the consumer is no longer required to carry a plurality of Private Identification Media to be able to access Private Accounts, which can now be accessed using a single Public Identification Medium. The ability to carry a Private Identification Medium instead of a Public Identification Medium is useful in situations where certain factors, e.g., risk of theft, might discourage carrying a Public Identification Medium. An example of this is at the beach, where it may be unwise to carry a Public Identification Medium, yet food can still be purchased using a Private Identification Medium for a given restaurant with minimal risk of loss. Further, the customer can instantly activate and access Private Identification Medium benefits without the need for an application or approval process, since blank Private Identification Media can be activated at the Self-Service Terminal. Another beneficial feature is the ability to create gift cards of arbitrary value by activating a new Private Identification Medium and associating cash value to it at the Self-Service Terminal. Along the same lines, customers have the ability to create cash value cards for children, who can use them (e.g., to buy food) without the need to carry cash or Public Identification Media. Moreover, customers can enjoy the ability to receive personalized service at the Self-Service Terminal because the Consumer Profile information is associated with a Private Identification Medium.

Insofar as the merchant is concerned, a system consistent with the present invention makes the Private Identification Medium value more attractive to the consumer, as discussed hereinabove. Further, there is an increased likelihood that the consumer will have appropriate Identification Media to use the Private Account benefits. Additionally, consumer barriers (e.g., paperwork and wait time) to the application process for Private Accounts are removed, since the application process can take place on a Self-Service Terminal, without the use of a cashier or other employee. Moreover, multiple customer service mechanisms (e.g., Private Identification Media, Public Identification Media, gift cards and credit slips or vouchers) can be unified in a single environment. Further, the overhead for administering Private Accounts and Private Identification Media is reduced due to the simplicity and automation provided by the Self-Service Terminal.

### Hardware and Software Configuration

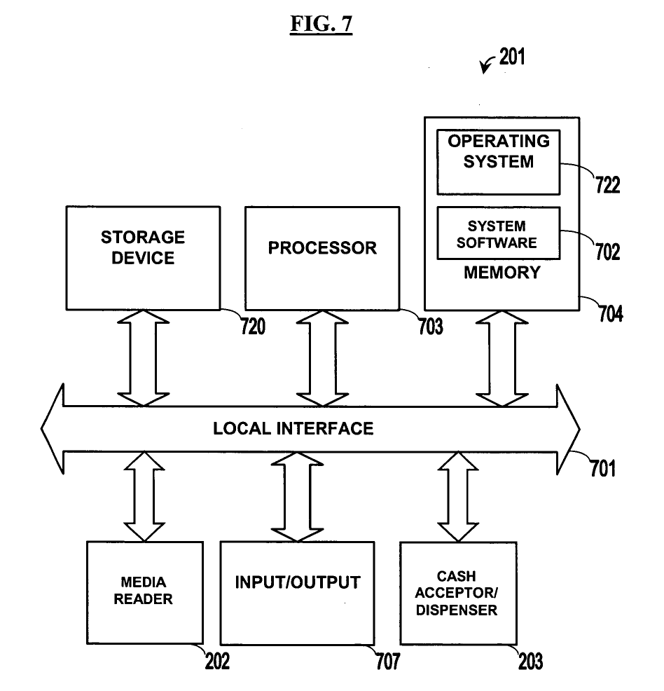

The Identification Medium System 200 of the present invention can be implemented in software (e.g., firmware), hardware, or a combination thereof. A portion of the system 200 is preferably implemented in software, as an executable program, and is executed by one or more special or general purpose digital computers, such as a personal computer (PC; IBM-compatible, Apple-compatible, or otherwise), workstation, minicomputer, or mainframe computer. Specifically, the Self-Service Terminal 201 is preferably implemented in software. An example of a general purpose computer that can serve as the Self-Service Terminal 201 of the present invention is shown in the block diagram of FIG. 7. In FIG. 7, the software that defines functionality performed by the system is denoted by reference numeral 702. Generally, in terms of hardware architecture, as shown in FIG. 7, the Self-Service Terminal 201 includes a processor 703, memory 704, media reader 202, cash acceptor/dispenser 203, and one or more other input and/or output (I/O) devices 707 (or peripherals) that are communicatively coupled via a local interface 701. The local interface 701 can be, for example but not limited to, one or more buses or other wired or wireless connections, as is known in the art. The local interface 701 may have additional elements, which are omitted for simplicity, such as controllers, buffers (caches), drivers, repeaters, and receivers, to enable communications. Further, the local interface may include address, control, and/or data connections to enable appropriate communications among the aforementioned components. It should be noted that the Self-Service Terminal 201 may also have a storage device 720 therein, which may also have the consumer profile database stored thereon, as is explained below. The storage device 720 may be any nonvolatile memory element (e.g., read only memory (ROM), hard drive, tape, CDROM, etc.).

The processor 703 is a hardware device for executing the system software 702, particularly that stored in memory 704. The processor 703 can be any custom made or commercially available processor, a central processing unit (CPU), an auxiliary processor among several processors associated with the Self-Service Terminal 201, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68 automated self-service series microprocessor from Motorola Corporation.

The memory 704 can include any one or combination of volatile memory elements (e.g., random access memory (RAM, such as DRAM, SRAM, SDRAM, etc.)) and nonvolatile memory elements. Moreover, the memory 704 may incorporate electronic, magnetic, optical, and/or other types of storage media. It is noted that the memory 704 can have a distributed architecture, where various components are situated remotely from one another, but can be accessed by the processor 703.

The system software 702 located in the memory 704 may include one or more separate programs, each of which comprises an ordered listing of executable instructions for implementing logical functions described above. In the example of FIG. 7, as mentioned above, the system software 702 includes functionality performed by the Self-Service Terminal 201 in accordance with the present invention and a suitable operating system (O/S) 722. A nonexhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). The operating system 722 essentially controls the execution of other computer programs, such as the system software 702 for the Self-Service Terminal 201, and provides scheduling, input-output control, file and data management, memory management, and communication control and related services.

The system software 702 is a source program, executable program (object code), script, or any other entity comprising a set of instructions to be performed. When a source program, then the program needs to be translated via a compiler, assembler, interpreter, or the like, which may or may not be included within the memory 704, so as to operate properly in connection with the O/S 722. Furthermore, the system software 702 can be written as: (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

In addition to the media reader 202 and cash acceptor/dispenser(s) 203, the I/O devices 707 may include input devices, for example but not limited to, a keyboard, mouse, scanner, microphone, touch-screen, etc. Furthermore, the I/O devices 707 may also include output devices, for example but not limited to, a printer, display, etc. The I/O devices 707 may further include devices that communicate both inputs and outputs, for instance but not limited to, a modulator/demodulator (modem; for accessing another device, system, or network), a radio frequency (RF) or other transceiver, a telephonic interface, a bridge, a router, etc. In accordance with present invention, at least one of the I/O devices 707 is a display, such as a computer screen.

If the Self-Service Terminal 201 is a PC, workstation, or the like, the system software 702 in the memory 704 may further include a basic input output system (BIOS) (omitted for simplicity). The BIOS is a set of essential software routines that initialize and test hardware at startup, start the O/S 722, and support the transfer of data among the hardware devices. The BIOS is stored in ROM so that the BIOS can be executed when the Self-Service Terminal 201 is activated.

When the Self-Service Terminal 201 is in operation, the processor 703 is configured to execute the system software 702 stored within the memory 704, to communicate data to and from the memory 704, and generally to control operations of the Self-Service Terminal 201 pursuant to the system software 702. The system software 702 and the O/S 722, in whole or in part, but typically the latter, are read by the processor 703, perhaps buffered within the processor 703, and then executed.

It should be noted that the system software 702 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The system software 702 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In embodiments wherein the system 200 is entirely implemented in hardware, the system 200 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The Consumer Profile database 210 (or a copy thereof) may be stored on the storage device 720 of the Self-Service Terminal 201, or alternatively, may be located remotely from the Self-Service Terminal 201, e.g., on a network-accessible computer.

Each of the functional components of the present invention may be embodied as one or more distributed computer program processes running on one or more conventional general purpose computers networked together by conventional networking hardware and software. Each of these functional components may be embodied by running distributed computer program processes (e.g., the Consumer Profile database 210 may be generated using “full-scale” relational database engines such as IBM DB2™, Microsoft SQL Server™, Sybase SQL Server™, or Oracle 8.0™ database managers, and/or a JDBC interface to link to such databases) on networked computer systems (e.g., comprising mainframe and/or symmetrically or massively parallel computing systems such as the IBM SB2™ or Hewlett-Packard 9000™ computer systems) including appropriate mass storage, networking, and other hardware and software for permitting these functional components to achieve the stated function. These computer systems may be geographically distributed and connected together via appropriate wide- and local-area network hardware and software. The present invention may use the public Internet and Internet compatible HTTP and UDP protocols for the network interconnections described herein, as well as the Federal Reserve Automated Clearing House (ACH) Network or other networks. The communications media described herein (generally referred to using the generic term “network”) may be a wired or wireless network, or a combination thereof.

Alternatively, the aforesaid functional components may be embodied by a plurality of separate computer processes (e.g., generated via an Xbase, dBase [a trademark of dBase, Inc.], Microsoft Access™ or other “flat file” type database management systems or products) running on IBM-type, Motorola, Intel™ or RISC microprocessor-based personal computers networked together via conventional networking hardware and software and including such other additional conventional hardware and software as is necessary to permit these functional components to achieve the stated functionalities. In this alternative configuration, since such personal computers typically are unable to run full-scale relational database engines of the types presented above, a non-relational flat file “table” may be included in at least one of the networked personal computers to represent at least portions of data stored by a system consistent with the present invention. The aforesaid functional components of a system consistent with the present invention may also comprise a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

As those in the art will recognize, possible embodiments of the invention may include one- or two-way data encryption and/or digital certification for data being input and output, to provide security to data during transfer. Further embodiments may comprise security means in the including one or more of the following: password or PIN number protection, use of a semiconductor, magnetic or other physical key device, biometric methods (including fingerprint, nailbed, palm, iris, or retina scanning, handwriting analysis, handprint recognition, voice recognition, or facial imaging), or other security measures known in the art. Such security measures may be implemented in one or more processes of the invention.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. An identification medium system, comprising:
storage for (1) a plurality of consumer profiles, each one of said consumer profiles comprising private account data relating to a consumer, (2) an association between a first account tag stored on a first identification medium and at least one said consumer profile, and (3) an association between a second account tag stored on a second identification medium and said consumer profile associated with said first account tag; and
a terminal in communication with said storage, said terminal comprising a memory, a processor, and at least one media reader adapted to read at least one of said first and second account tags,
wherein said processor is configured by said memory to permit retrieval or modification of at least a portion of said private account data of said consumer profile associated with said first account tag upon said media reader reading said at least one of said first or second account tags.

2. The system of claim 1, wherein said second identification medium is a credit or debit card.

3. The system of claim 1, wherein said private account data includes an account balance, and wherein said modification of said private account data comprises updating said account balance.

4. The system of claim 3, wherein said terminal further comprises a cash receiver or dispenser, and wherein said updating of said account balance is performed based on cash received or dispensed at said terminal.

5. The system of claim 1, wherein said processor is further configured by said memory to permit an order or a purchase of a good or a service upon reading said second account tag stored on said second identification medium and to update said private account data based on said order or purchase.

6. The system of claim 1, wherein said private account data includes at least one item selected from the group consisting of name, age, address, and telephone number.

7. The system of claim 1, wherein said private account data includes purchase history data.

8. An identification medium system, comprising:
a computer-readable medium having a plurality of consumer profiles stored thereon, each one of said consumer profiles comprising private account data relating to a consumer; and
a terminal in communication with said computer-readable medium, said terminal comprising a processor, a memory, and at least one media reader adapted to read (1) a first account tag stored on a first identification medium, wherein said first account tag corresponds to at least one said consumer profile, and (2) a second account tag stored on a second identification medium,
wherein said processor is configured by said memory (1) to store on said computer-readable medium an association between said second account tag and said consumer profile corresponding to said first account tag, and (2) to permit retrieval or modification of at least a portion of said private account data of said consumer profile corresponding to said first account tag upon subsequent reading by said media reader of said second account tag stored on said second identification medium.

9. The system of claim 8, wherein said second identification medium is a credit or debit card.

10. The system of claim 8, wherein said private account data includes an account balance, and wherein said modification of said private account data comprises updating said account balance.

11. The system of claim 10, wherein said terminal is further adapted to receive or dispense cash, and wherein said updating of said account balance is performed based on cash received or dispensed at said terminal.

12. The system of claim 8, wherein said processor is further configured by said memory to permit an order for or a purchase of a good or a service upon reading by said media reader of said second account tag stored on said second identification medium and to update said private account data based on said order or purchase.

13. The system of claim 8, wherein said private account data includes at least one item selected from the group consisting of name, age, address, and telephone number.

14. The system of claim 8, wherein said private account data includes purchase history data.

15. A method of performing a transaction in an identification medium system, comprising the steps of:
storing a plurality of consumer profiles, each one of said consumer profiles comprising private account data relating to a consumer;
reading a first account tag stored on a first identification medium, wherein said first account tag corresponds to at least one said consumer profile;
reading a second account tag stored on a second identification medium;
storing an association between said second account tag and said consumer profile corresponding to said first account tag; and
permitting retrieval or modification of at least a portion of said private account data of said consumer profile corresponding to said first account tag upon subsequent reading of said second account tag stored on said second identification medium.

16. The method of claim 15, wherein said second identification medium is a credit or debit card.

17. The method of claim 15, wherein said private account data includes an account balance, and wherein said modification of said private account data comprises updating said account balance.

18. The method of claim 17, further comprising the step of:
receiving or dispensing cash, wherein said updating of said account balance is performed based on said cash received or dispensed.

19. The method of claim 15, further comprising the steps of:
permitting an order or a purchase of a good or a service upon reading of said second account tag stored on said second identification medium; and
updating said private account data based on said order or purchase.

20. The method of claim 15, wherein said private account data includes at least one item selected from the group consisting of name, age, address, and telephone number.

21. The method of claim 15, wherein said private account data includes purchase history data.

22. A method of performing a transaction in an identification medium system, comprising the steps of:
storing (1) a plurality of consumer profiles, each one of said consumer profiles comprising private account data relating to a consumer, (2) an association between a first account tag stored on a first identification medium and at least one said consumer profile, and (3) an association between a second account tag stored on a second identification medium and said consumer profile associated with said first account tag, wherein said second identification medium is a public identification medium; and
permitting retrieval or modification of at least a portion of said private account data of said consumer profile associated with said first account tag upon reading of said second account tag stored on said second identification medium.

23. The method of claim 22, wherein said second identification medium is a credit or debit card.

24. The method of claim 22, wherein said private account data includes an account balance, and wherein said modification of said private account data comprises the step of updating said account balance.

25. The method of claim 23, further comprising the step of:
receiving or dispensing cash, wherein said updating of said account balance is performed based on said cash received or dispensed.

26. The method of claim 22, further comprising the steps of:
permitting an order for or a purchase of a good or a service upon reading of said second account tag stored on said second identification medium; and
updating said private account data based on said order or purchase.

27. The method of claim 22, wherein said private account data includes at least one item selected from the group consisting of name, age, address, and telephone number.

28. The method of claim 22, wherein said private account data includes purchase history data.

29. An identification medium system, comprising:
means for storing a plurality of consumer profiles, each one of said consumer profiles comprising private account data relating to a consumer;
means for storing an association between a first account tag stored on a first identification medium and at least one said consumer profile;
means for storing an association between a second account tag stored on a second identification medium and said consumer profile associated with said first account tag;
means for reading at least one of said first and second account tags; and
means for permitting retrieval or modification of at least a portion of said private account data of said consumer profile associated with said first account tag upon reading of said at least one of said first or second account tags.

30. An identification medium system, comprising:
means for storing a plurality of consumer profiles, each one of said consumer profiles comprising private account data relating to a consumer;
means for reading (1) a first account tag stored on a first identification medium, wherein said first account tag corresponds to at least one said consumer profile, and (2) a second account tag stored on a second identification medium;
means for storing an association between said second account tag and said consumer profile corresponding to said first account tag; and
means for permitting retrieval or modification of at least a portion of said private account data of said consumer profile corresponding to said first account tag upon subsequent reading of said second account tag stored on said second identification medium.
